(19) United States
(12) Patent Application Publication
(10) Pub. No.: US 2012/0033437 A1
(43) Pub. Date: Feb. 9, 2012

(54) ADJUSTABLE LAMP ASSEMBLY

(75) Inventors: Morris Gary Grossman, Riverside, CT (US); Keith Kristiansen, Stratford, CT (US); Roland Charriez, Plattekill, NY (US); Richard Daniel Bolduc, JR., Clearwater, FL (US)

(73) Assignee: OttLite Technologies, Inc., Tampa, FL (US)

(21) Appl. No.: 13/204,196

(22) Filed: Aug. 5, 2011

Related U.S. Application Data
(60) Provisional application No. 61/371,449, filed on Aug. 6, 2010.

(51) Int. Cl. F21V 21/00

(52) U.S. Cl. 362/419

(57) ABSTRACT

An adjustable lamp assembly involving a plurality of operably-coupled sections that function together and allow the assembly to be selectively adjustable between a retracted configuration and an extended configuration. In the retracted configuration, an extendable portion of the assembly is effectively concealed from view; while in the extended configuration, the extendable portion is positioned in view and oriented as desired. When using such lamp assembly, the assembly can be selectively adjusted between having a clean and shallow profile that enhances its aesthetic appearance and having a diffuse and extended profile that enhances its efficiency for a user.

### CROSS REFERENCE TO RELATED APPLICATIONS

This application claims priority to U.S. Provisional Application No. 61/371,449 filed Aug. 6, 2010, the teachings of which are incorporated herein by reference.

### BACKGROUND

1. Field of the Invention

The present invention relates to lighting apparatus, and more particularly, to lighting apparatus that is adjustable to multiple configurations via its assembly.

2. Description of the Related Prior Art

Lighting apparatus can be grouped into two basic groups: adjustable and non-adjustable. Some smaller-scale lamps are made to be adjustable; however, this is not the case for all. As is known, many smaller-scale lamps are designed for use on tables, most notably desks. In most cases, such lamps are configured to be easily portable in their entireties. Consequently, such lamps can be moved closer to areas where light is needed, e.g., working or reading areas. However, if such lamps are not also configured to ably direct light in a collective fashion to specific areas of need, the lamps can be found quite inefficient, i.e., the amount of light emitted from the lamp being a much higher percentage than the amount that can be effectively used by a user.

The reason for the inefficiency of such smaller non-adjustable lamps is that they are often designed to provide concentric distribution, and result in a generalized type of lighting for a circular area surrounding the lamp. This type of light distribution often involves the lamp having a primarily vertical construction that often is aesthetically pleasing to the onlooker. However, as described above, such lamp design does a rather poor job of collectively directing light for a person working at, or proximate to the lamp, because a significant portion of the light generated from the lamp is not aptly directed for the person's use. Therefore, while such non-adjustable lamps have a desirable aesthetic appearance, they often lack in efficiency.

On the other hand, adjustable lamps typically have one or more portions thereof which can be oriented to collectively direct the light generated there. As a result, they would be considered more efficient with respect to use of such light. However, these lamp designs often involve the one or more portions to angularly project outward from the lamp. Such projection of the one or more lamp portions, unfortunately, tends to compromise the lamp's aesthetic appearance. Accordingly, with such adjustable lamps, their aesthetic appearance is sacrificed for the lamp's overall efficiency.

In light of the above, lamp designers and manufacturers are often left in a bit quandary in deciding whether a lamp should be created for aesthetic value or for adjustability. The present invention solves these and other problems.

### SUMMARY OF THE INVENTION

Embodiments of the adjustable lamp assembly of the present invention involve a plurality of operably-coupled sections that function together and allow the assembly to be selectively adjustable between a retracted configuration and an extended configuration. In such retracted configuration, an extendable section of the assembly is effectively concealed from view; while in such extended configuration, the extendable section is positioned in view and oriented as desired. Consequently, when using such lamp assembly, the assembly can be selectively adjusted between having a clean and shallow profile that enhances its aesthetic appearance and having a diffuse and extended profile that enhances its efficiency for a user.

### DESCRIPTION OF THE DRAWINGS

FIG. 1 is a front perspective view of a lamp assembly shown in a retracted configuration in accordance with certain embodiments of the invention.

FIG. 2 is a front elevation view of the lamp assembly of FIG. 1.

FIG. 3 is a side elevation view of the lamp assembly of FIG. 1.

FIG. 4 is a top view of the lamp assembly of FIG. 1.

FIG. 5 is a front perspective view of the lamp assembly of FIG. 1 in an extended configuration and directed in one orientation in accordance with certain embodiments of the invention.

FIG. 6 is another front perspective view of the lamp assembly of FIG. 5 directed in another orientation in accordance with certain embodiments of the invention.

FIG. 7 is a side view of a cutout portion of a base section of the lamp assembly of FIG. 1 in accordance with certain embodiments of the invention.

### DETAILED DESCRIPTION

The following detailed description should be read with reference to the drawings, in which like elements in different drawings are numbered identically. The drawings depict selected embodiments and are not intended to limit the scope of the invention. It will be understood that embodiments shown in the drawings and described below are merely for illustrative purposes, and are not intended to limit the scope of the invention as defined in the claims.

In the description herein, the term “lamp assembly” is used generally to represent lighting apparatus that is designed to work in conjunction with a light source. While lamp assemblies embodied herein may most notably be associated with table or desk lamps, the invention should not be limited thereto. Instead, the embodiments of the invention described herein are just as applicable to wall- or floor-mounted lamps and/or lamps integrally configured to direct light, yet by their design, lack the ability for such direction to be widely adjusted. Likewise, the term “light source” is used generally herein to represent any source of light that can be directed with the lamp assembly. For example, the light source can involve any means designed to emit light there from, including those sources configured with an outer bulb envelope. In other cases, the light source can simply be a form of light that is harnessed by the lamp assembly and then redirected from the assembly. As alluded to above, it should be understood that description of these few examples are not meant to limit the uses of the embodied adjustable lamp assembly, but conversely to provide a sense of these and other potential applications that the present invention avails itself to.

As described above, the adjustable lamp assembly of the present invention as embodied herein involves a plurality of operably-coupled sections that function together, allowing the assembly to be selectively adjustable between a retracted configuration and an extended configuration. In the retracted configuration, an extension of the assembly is effectively concealed from view; while in the extended configuration, the extension is revealed and can be oriented as desired. Consequently, when using such lamp assembly, the assembly can be selectively adjusted between having a streamlined profile that enhances its aesthetic appearance and having a protruding profile that enhances its efficiency for a user.

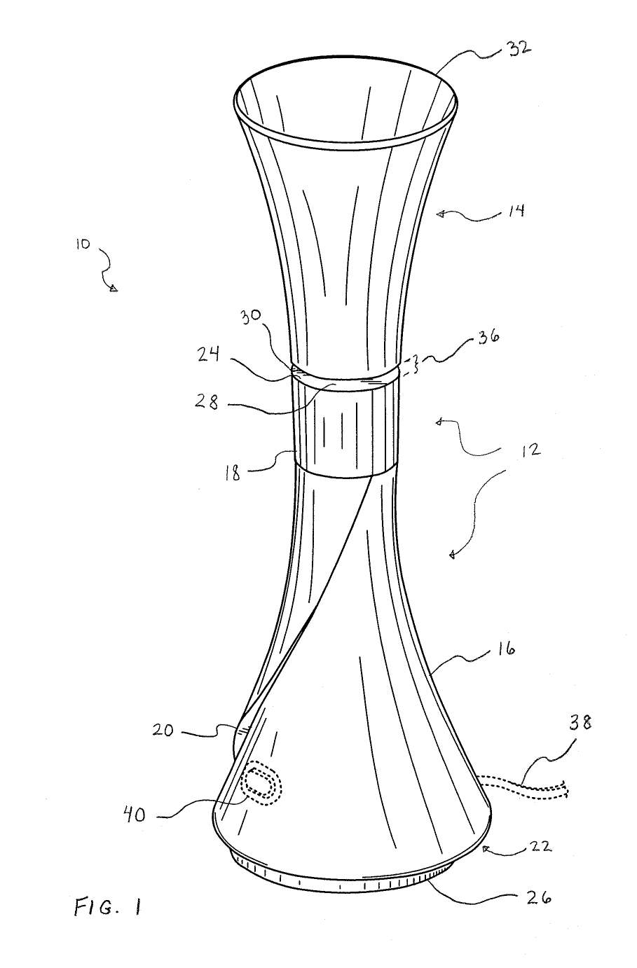

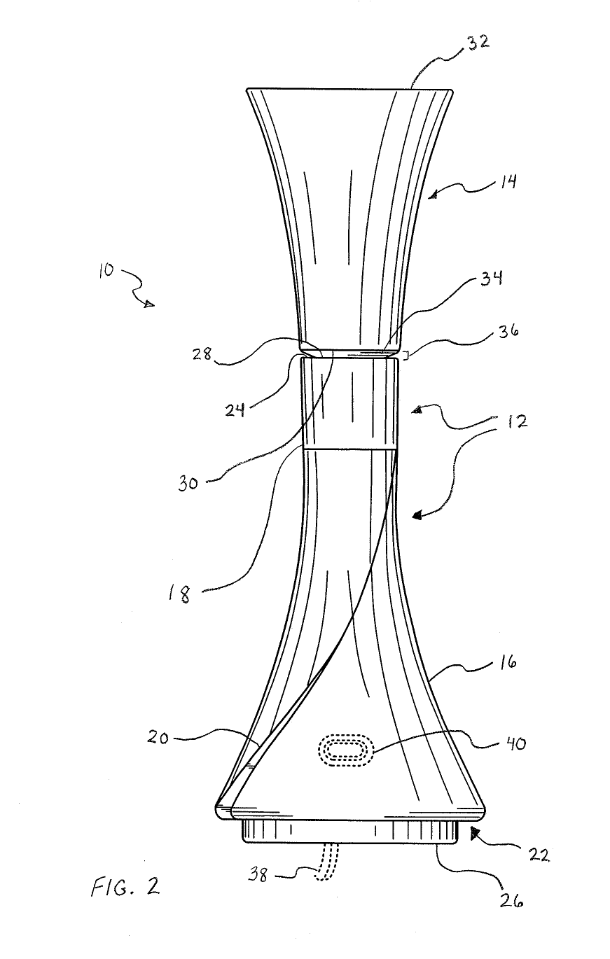

FIG. 1 is a front perspective view of a lamp assembly in a retracted configuration in accordance with certain embodiments of the invention, while FIGS. 2-4 are alternate views of the lamp assembly in the same configuration. As shown, the lamp assembly 10 includes a base section 12 and a shroud section 14, where when the assembly is in its retracted configuration, the sections 12, 14 are operatively joined. In certain embodiments, the base section 12 and shroud section 14 are formed of plastic, such as ABS plastic; however, the sections 12, 14 could be alternately formed of another material or a combination of any desirable materials.

The base section 12 can be formed of one or more portions. For example, in certain embodiments, as shown, the base section 12 can be formed of two or more longitudinally-extending segments, including a first such segment 16 being adjacent to a second such segment 18. As shown, such first and second segments 16, 18 can share certain qualities, yet be distinct with respect to other qualities. For example, in certain embodiments, the first and second segments 16, 18 can each have a similarly-shaped end, both of which align with each other in forming a substantially smooth outer surface for the base section 12. Alternatively or in combination with the above, in certain embodiments, one or more portions of the base section 12, e.g., the first segment 16, can include an outward aesthetic quality 20, while one or more other portions of the base section 12, e.g., second segment 18, may be without such aesthetic quality. As shown, such aesthetic quality 20 can be a ruffled shape; however it should be appreciated that other shapes and/or aesthetic features could just as well be used in substitute or combination. Reasons for such aesthetic differences between the two segments 16, 18 will be described herein.

As described above, the base section 12 and the shroud section 14 are operatively joined. In certain embodiments, as shown in FIGS. 1-3, when the lamp assembly 10 is in its retracted configuration, the sections 12, 14 are oriented so that they substantially align, thereby collectively forming a structure having a streamlined profile. The base section 12 includes first and second opposing ends 22 and 24. In certain embodiments, the first end 22 forms a base 26 for the lamp assembly 10, while the second end 24 forms a platform 28 for the shroud section 14. In certain embodiments, as shown, the second end 24 or platform 28 is configured to lie in contact with the shroud section 14 when the lamp assembly 10 is in its retracted configuration. Similar to the base section 12, the shroud section 14 also has first and second opposing ends 30 and 32. As such, the base section second end 24 (the platform 28) and the shroud section first end 30 close together when the lamp assembly 10 is adjusted to in its retracted configuration, as will be further described herein.

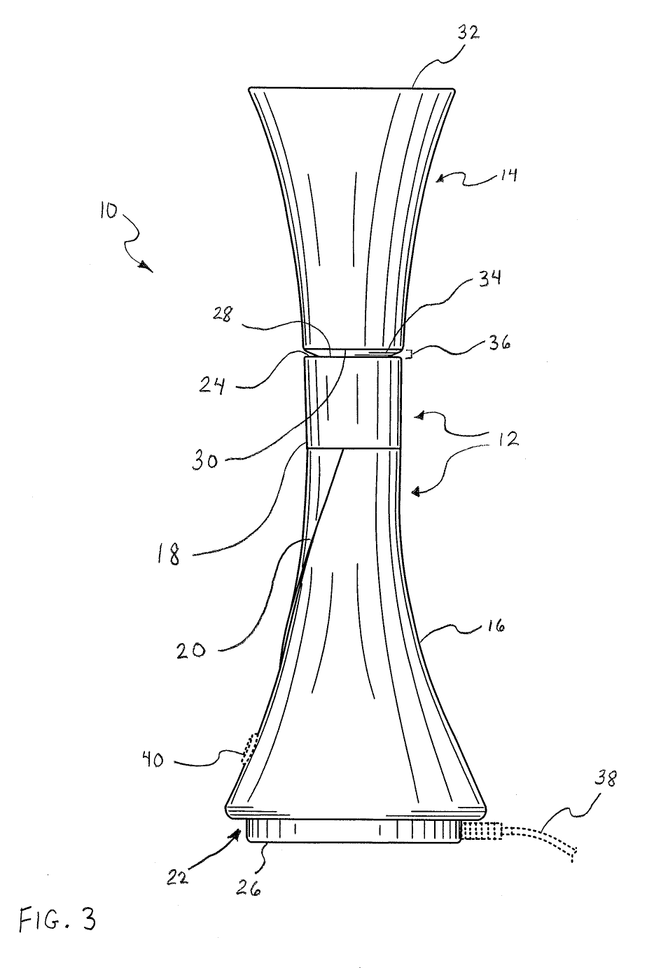

In certain embodiments, the mating ends 24, 30 of the base and shroud sections 12, 14, respectively, have differing outer surface profiles. In certain embodiments, one of the ends 24, 30 narrows axially with respect to the other. For example, as best exemplified in FIGS. 2 and 3, the shroud section first end 30 has an outer surface profile 34 that protrudes outward there from. In one such configuration, as illustrated, the profile 34 can be conically shaped so as to extend away from the shroud section first end 30 in a narrowing manner. However, the invention should not be limited to such. For example, the outer surface profile 34 can be shaped as desired. In addition, while such profile 34 is embodied herein as stemming from the shroud section 14, such profile could alternatively stem from the base section 12, most notably, the base section second end 24. In either case, an indentation 36 would be formed that circles the lamp assembly 10 between the base and shroud sections 12, 14. Reasons for having such indentation 36 between the two sections 12, 14 will be described herein.

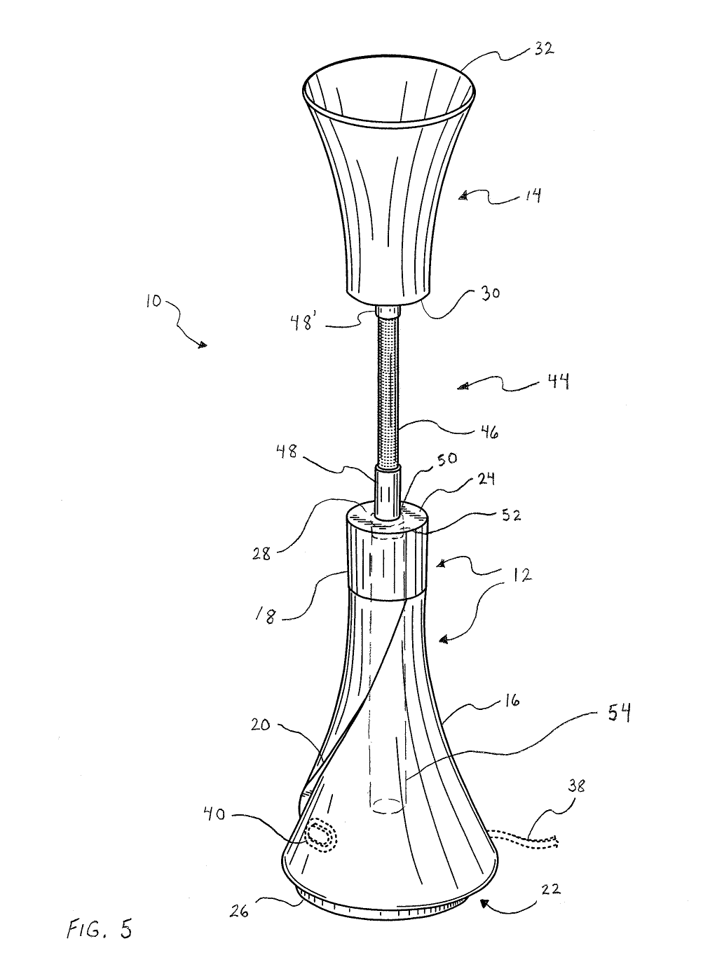

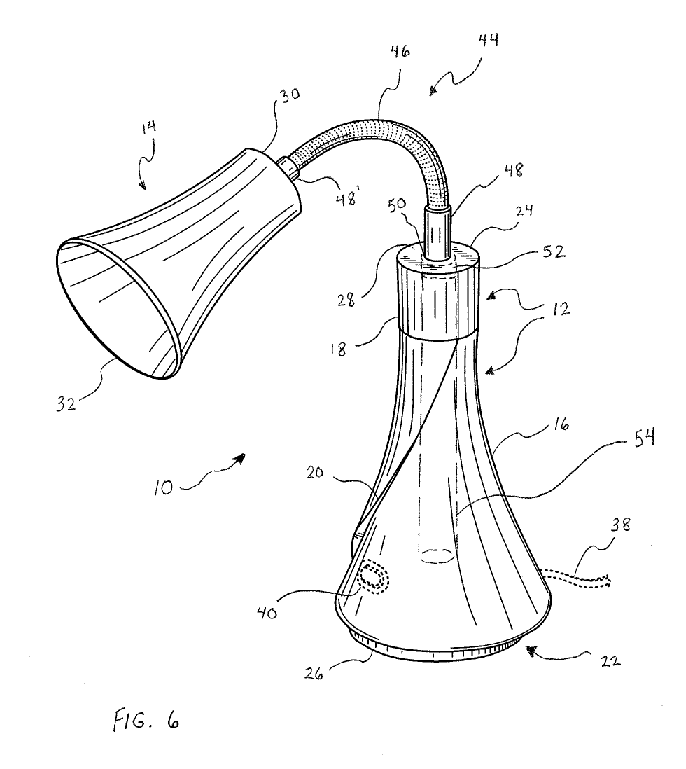

Some other features of the lamp assembly 10 depicted in each of the FIGS. 1-4 (as well as FIGS. 5 and 6, not yet discussed) relate to mechanisms for powering the lamp assembly 10. As perhaps best shown in FIG. 3, in certain embodiments, the assembly 10 has an electrical cord 38 (partially shown in dashed lines) feeding into the base 26 for providing a source of electric power. However, providing power to the lamp assembly 10 in this fashion should not limit the invention. For example, the assembly 10 could just as well be powered wirelessly, e.g., through batteries or other power storage means. In turn, while not being visibly shown, electrical continuity extends from the terminal end of the cord 38 into the assembly 10 and onto a power button 40, exemplarily located on the lower section 16 for clear accessibility for the user. In certain embodiments, the power button 40 can be a single pole switch; however, such switch could be further configured as desired. For example, the switch can be equipped with one or more of dimming and/or timing functionalities, the configuration of which would be known to the skilled artisan.

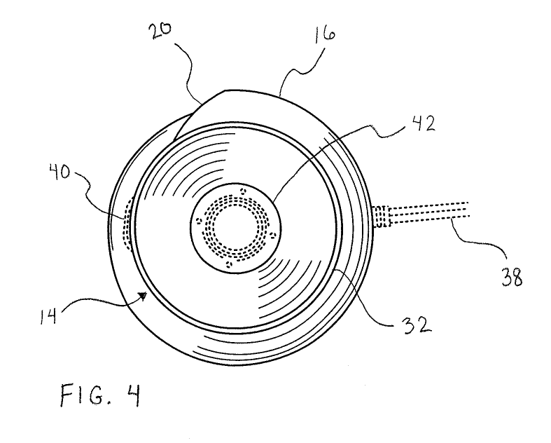

Electrical continuity would further internally extend from the power button 40 onto the light source of the lamp assembly 10. In certain embodiments, the assembly 10 is configured to electrically accept the light source within its shroud section 14. For example, as shown in FIG. 4, the shroud section 14 includes an electrical socket 42 for the light source to be accepted therein. While not being shown, in certain embodiments, the light source can involve a simple incandescent bulb. However, the light source, instead of being powered directly through an electric feed, may alternatively need to be initially manipulated, e.g., by ballast means, such as for fluorescent or high-intensity discharge lighting sources. As would be understood, such initial manipulation means could be integral to the light source, but it may also be designed to be remote from the light source. In such cases, such means could be held within, or remote to, the base section 12 of the lamp assembly 10.

As described above, it has been problematic for designers and manufacturers in creating a lamp that exhibits aesthetically-pleasing properties while also being adjustable to exhibit enhanced efficiency for a user. One way to hit upon both these advantageous properties is through the lamp assembly 10 described herein. Through the description with reference to FIGS. 1-4, applicants have described a retracted configuration of the lamp assembly 10, whereby the assembly 10 has a streamlined profile for aesthetically-pleasing purposes. However, in that configuration, the assembly 10 provides light, but not in a manner so as to be collectively directed for ideal lighting conditions, e.g., for working or reading under. The lamp assembly 10, as further described herein, addresses such issues.

FIGS. 5 and 6 are front perspective views of the lamp assembly 10 in an extended configuration and exemplarily directed in different orientations in accordance with certain embodiments of the invention. In such extended configuration, as shown, the shroud section 14 is extended apart from the base section 12, with the sections 12, 14 continuing to be operatively joined. As shown, the sections 12, 14 are so joined via a neck section 44. As shown, the neck section 44 includes tubing 46 formed of material that while having certain elastic properties, possesses certain rigidity so as to maintain its shape after being oriented as desired. In certain embodiments, such tubing material is braided steel; however, other materials exhibiting like properties can be alternately used, such as braided aluminum. The length of the tubing 46 can be varied as desired, so long as the length does not impede the collective rigidity properties thereof. In certain embodiments, such length is no more than about 18″. In more preferable embodiments, such length is no more about 12″, and in most preferred embodiments, such length is between about 6″ and 12″.

As shown, secured on the opposing ends of the tubing 46, i.e., at the base section second end 24 and at the shroud section first end 30, are couplings 48 and 48′, respectively. In certain embodiments, as shown, the couplings 48, 48′ are tube-shaped segments that have a slightly larger outer diameter than that of the tubing 46. In certain embodiments, the couplings 48, 48′ are formed of a rigid material, such as steel. In certain embodiments, the couplings 48, 48′ have smaller outer diameters than the diameter of an opening 50 defined in the end 24 of the base section 12. As a result, the couplings 48, 48′, along with the tubing 46, are configured to pass relatively undeterred as they emerge or are fed into the opening 50.

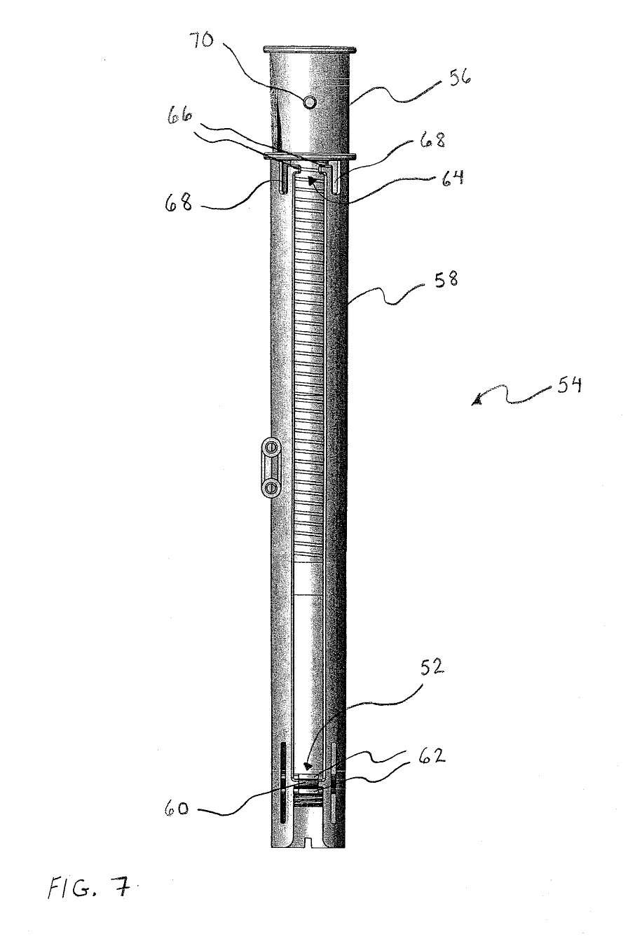

In certain embodiments, a supporting assembly 52 is secured to the coupling 48 at an end opposite the coupling end attached to the tubing 46. Such assembly 52 is shown in FIG. 7, which illustrates a side view of an internal portion of the base section 12 in accordance with certain embodiments of the invention. As shown, the internal portion involves a channel 54, within which the supporting assembly 52 is positioned, and along its extent which the assembly 52 is configured to travel. As shown, in certain embodiments, the channel 54 includes a first portion 56 configured to substantially lie within the second segment 18 of the base section 12, and a second portion 58 extending into the first segment 16 of the base section 12. In certain embodiments, the channel 54 is configured to house, and thereby to visibly conceal, the neck section 44 when the lamp assembly 10 is in the retracted configuration. The first and second portions 56, 58 of the channel 54 can be formed of plastic, e.g., ABS plastic; however, such the materials of such portions 56, 58 could be formed of another materials or material combinations as desired.

As described above, the supporting assembly 52 is positioned within the channel 54, and is kept therein in both the retracted and extended configurations of the lamp assembly 10. In certain embodiments, the assembly 52 involves a ring gasket 60 sandwiched between a pair of plastic rings 62. As such, one of the plastic rings 62 is secured to the coupling 48 at an end opposite the coupling end attached to the tubing 46. Accordingly, when the lamp assembly 10 is in the retracted configuration, the supporting assembly 52 lies at a proximal end of the channel 54 (as is shown in FIG. 7), yet lies at a distal end of the channel 54 when the lamp assembly 10 is in the extended configuration (as shown in FIGS. 5 and 6). In such extended configuration, the assembly 52 comes into contact with a catch 64 of the channel 54.

In certain embodiments, the catch 64 is formed of a pair of protrusions 66, e.g., prongs, which extend from opposing sides of the channel 54 at the distal end thereof. In certain embodiments, the protrusions 66 are oriented inward in the channel 54 so as to releasably interlock with the supporting assembly 52 as it passes thereby. In particular, the protrusions 66 are flanked externally by slots 68, enabling the protrusions 66 to bend outward to accept the supporting assembly 52 there between, and then to snap back inward to close upon the assembly 52, thereby interlocking the assembly 52 there between. In certain embodiments, the protrusions 66 close upon the ring gasket 60 of the assembly 52 as such gasket 60 is formed of an elastic material, such as rubber. In turn, once the protrusions 66 snap back inward to close upon the ring gasket 60, the surrounding plastic rings 62 of the supporting assembly 52 sandwich such protrusions 66, providing a secure linkage between the assembly 52 and the channel 54.

In certain embodiments, the protrusions 66 are formed of plastic, such as ABS plastic, and as shown, project from opposing sides of the channel 54 of the base section 12. Further, in certain embodiments, the first portion 56 of the channel 54 includes a pair of fasteners 70 (only one of which is shown in FIG. 7) on opposing sides of the channel 54 which are used to secure such portion 56 to the base section 12, most notably, the second segment 18 thereof. Such securement of the first portion 56 to the second segment 18 prevents the channel 54 from moving, e.g., spinning, with respect to the base section 12 when the lamp assembly 10 is in the extended configuration and the shroud section 14 is oriented as desired.

As shown in FIGS. 5 and 6, in certain embodiments, the channel 54 (shown with dashed lines) extends downward into the base section 12 from its opening 50. As described above, such channel 54 is sized to contain the coupling 48 and tubing 46 when the lamp assembly 10 is in the retracted configuration. The ring gasket 60 and plastic clips 62 of the supporting assembly 52 have outer diameters that are substantially similar to an inner diameter of the channel 54 such that the outer surfaces of the assembly 52 and inner surface of the channel 54 are in loose contact there between as the assembly 52 is moved within the channel 54. Such contact between the supporting assembly 52 and the channel 54 serves to substantially secure the shroud section 14 to the base section 12 when the lamp assembly 10 is in the retracted configuration.

The method of converting the lamp assembly 10 from its extended configuration to its retracted configuration, and vice versa, is further detailed below. As described above, in the retracted configuration, the base and shroud sections 12, 14 are operatively joined. In certain embodiments, as described above, such joining of the sections 12, 14 is a function of the channel 54. The coupling 48′ is secured to the first end 30 of the shroud section 14 via the use of fastening means, such as fasteners, adhesive, clamps, or the like. Consequently, when the lamp assembly 10 is converted from its extended configuration to its retracted configuration, a downward force is exerted on the tubing 46 so as to free the supporting assembly 52 from the catch 64. In turn, the coupling 48 and tubing 46 of the neck section 44 are freely fed into the channel 54 through the base section opening 50 until contact is made between the ends 24, 30 of the base and shroud sections 12, 14. As a result, once contact is made between the ends 24, 30, the neck section is held within the channel 54 and visibly concealed from view. The channel 54, as a consequence of it securely contacting the supporting assembly 52 therein, provides a secure joining of the shroud section 14 with the base section 12.

Conversely, when the lamp assembly 10 is converted from its retracted configuration to its extended configuration, the shroud section 14 is pulled apart from the base section 12. The loose contact between the supporting assembly 52 and the channel 54 provides some measure of resistance such that the neck section 44 does not slide back within the base section 12 in the event of temporarily releasing such pulling force. In pulling the shroud section 14 from the base section 12, the tubing 46 emerges through the opening 50 and out of the base section 12. In so doing, the other coupling 48 emerges from the opening 50 until the supporting assembly 52 secured thereto travels between the catch 64, where upon it interlocks with the assembly 52. As a consequence, the coupling 48 is in turn suspended by the catch 64 and provides a secure supporting device for the shroud section 14 in its extended state.

From this description, it should be appreciated that the lamp assembly 10, through its transformative properties, provides a lamp that exhibits aesthetically-pleasing properties in one configuration, while being easily adaptable to exhibit high lighting efficiency if and when needed. Accordingly, the lamp assembly 10 would be ideal for endless applications in which general lighting from a streamlined, more aesthetically pleasing lamp is required at certain times, yet which is adjustable so as to direct the generated light in a collective fashion, thereby making the lamp more efficient for working, reading, etc. To that end, as illustrated in FIGS. 5 and 6, the adjustability of the lamp assembly 10 in its extended configuration, via the flexible tubing 46 of its neck section 44, provides virtually unlimited versatility with respect to directing the light.

Additional design considerations alluded to above can now be addressed. Creation of the indentation 36 between the base and shroud sections 12, 14 via the outer surface profile 34 on one of the base section second end 24 or the shroud section first end 30 forms a catch for the user to utilize. In use, such catch provides a starting point for the user as he pulls the shroud section 14 from the base section 12. Once the shroud section 14 begins to pull free, the indentation 36 widens, thereby presenting the user an improved region to continue pulling from at the shroud section end 30. Consequently, the user is not otherwise motivated to shift his grasp at the opposing end 32 of the section 14. Such opposing end 32 can often be more delicate and fragile than other end 30 of the shroud section 14; therefore, handling of such is intended to be limited.

Motivation for differing aesthetics between the first and second segments 16, 18 of the base section 12 is derived from the manner in which the lamp assembly 10 is converted between configurations. As described above, in certain embodiments, the first segment 16 is provided with an aesthetic quality 20, while the second segment 18 lacks such a quality. From the figures, as the second segment 18 forms the base section end 24, it is touched/handled more often then the first segment 16, particularly in converting the lamp assembly 10 from one configuration to the other, and vice versa. Consequently, it would be preferable for the second segment 18 to not share the aesthetic quality because such second segment 18 is more prone to marking from such periodic touching/handling Accordingly, in certain embodiments, the second section 18 is without aesthetic feature, or alternately, lacking the same aesthetic feature of the first section 16, so that any marking/scuffing of the second segment 18 does not detract from the aesthetic quality 20 of the first segment 16.

In light of the above, the second segment 18 can be of substantially less size than that of the first segment 20. In certain embodiments, the second segment 18 is no more than about 25% of a comparable size as that of the first segment 20. In preferred embodiments, the second segment 18 is no more than about 15% of a comparable size as that of the first segment 20. In most preferred embodiments, the second segment 18 is no more than between about 10% and 15% of a comparable size as that of the first segment 20.

It should be appreciated that in describing herein that the lamp assembly 10 has a retracted configuration and an extended configuration, it could just as well be described and intends the same meaning as describing that the shroud section 14 of the lamp assembly 10 has a retracted configuration and an extended configuration. This is because the shroud section 14 forms a part of the lamp assembly 10 that is being extracted and retracted relative to the base section 10. It will be appreciated the embodiments of the present invention can take many forms. The true essence and spirit of these embodiments of the invention are defined in the appended claims, and it is not intended the embodiment of the invention presented herein should limit the scope thereof.

What is claimed is:

1. A lamp assembly, comprising
(a) a base section;
(b) a shroud section for holding a light source for the lamp assembly, the shroud section operatively joined to the base section, the shroud section being adjustable between at least two configurations, a first of the at least two configurations involving the shroud section being secured to the base section such that the lamp assembly has a streamlined profile, and a second of the at least two configurations involving the shroud section being extended from the base section such that the shroud section can be oriented in any of a plurality of directions; and
(c) a neck section joining the base section to the shroud section, the neck section being visibly concealed when the shroud section is in the first configuration.

2. The lamp assembly of claim 1 wherein the neck section comprises tubing.

3. The lamp assembly of claim 2 wherein the tubing has flexible rigidity such that the orientation of the shroud section is maintainable when in the second configuration.

4. The lamp assembly of claim 3 wherein the tubing comprises braided steel.

5. The lamp assembly of claim 2 wherein couplings are provided on ends of the tubing, the couplings having a larger outer diameter than the tubing.

6. The lamp assembly of claim 5 wherein one of the couplings interlocks with a catch of the base section so as to securely support the neck section and the shroud section when the shroud section is in the second configuration.

7. The lamp assembly of claim 1 wherein the base section comprises a channel that extends internally from an opening defined in the base section, the neck section held within the channel when the shroud section is in the first configuration.

8. The lamp assembly of claim 1 wherein an indentation is defined between the base section and shroud section when the shroud section is in the first configuration, where said indentation forms a catch to utilize in adjusting the shroud section from its first configuration to its second configuration.

9. The lamp assembly of claim 8 wherein the indentation is formed via a protruding outer surface profile from an end of one of the base section and the shroud section, wherein the profile suspends the end of the shroud section from entirely contacting the end of the base section when the shroud section is in the first configuration.

10. The lamp assembly of claim 1 wherein the base section is formed of a first segment and a second segment, the first and second segments being adjacent to each other with the second segment being more proximate to an end of the base section than the first section, and the first segment having an aesthetic quality as compared to the second segment.

11. The lamp assembly of claim 10 wherein the first segment and the second segment have similarly-shaped ends which align with each other in forming a substantially smooth surface for the base section.

12. A lamp assembly, comprising
(a) a base section;
(b) a shroud section for holding a light source for the lamp assembly, the shroud section operatively joined to the base section, the shroud section being adjustable between at least two configurations, a first of the at least two configurations involving the shroud section being secured to the base section such that the lamp assembly has a streamlined profile, and a second of the at least two configurations involving the shroud section being extended from the base section such that the shroud section can be oriented in any of a plurality of directions; and
(c) a neck section joining the base section to the shroud section, the neck section comprising tubing and a coupling provided on each end of the tubing, wherein a first of the couplings is secured with the shroud section and a second of the couplings interlocks with a catch of the base section so as to securely support the neck section and the shroud section when the shroud section is in the second configuration.

13. The lamp assembly of claim 12 wherein the neck section is visibly concealed when the shroud section is in the first configuration.

14. The lamp assembly of claim 12 wherein the base section comprises a channel that extends internally from an opening defined in the base section, the neck section held within the channel when the shroud section is in the first configuration.

15. The lamp assembly of claim 12 wherein the tubing has flexible rigidity such that the orientation of the shroud section is maintainable when in the second configuration.

16. The lamp assembly of claim 12 wherein the second coupling is operatively coupled to a supporting assembly and the catch comprises protrusions that interlock with the supporting assembly when the shroud section is in the second configuration.

17. The lamp assembly of claim 12 wherein an indentation is defined between the base section and shroud section when the shroud section is in the first configuration, where said indentation forms a catch to utilize in adjusting the shroud section from its first configuration to its second configuration.

18. The lamp assembly of claim 12 wherein the base section is formed of a first segment and a second segment, the first and second segments being adjacent to each other with the second segment being more proximate to an end of the base section than the first section, and the first segment having an aesthetic quality as compared to the second segment.

19. A lamp assembly, comprising
(a) a base section; and
(b) a shroud section for holding a light source for the lamp assembly, the shroud section operatively joined to the base section, the shroud section being adjustable between at least two configurations, a first of the at least two configurations involving the shroud section being secured to the base section such that the lamp assembly has a streamlined profile, and a second of the at least two configurations involving the shroud section being extended from the base section such that the shroud section can be oriented in any of a plurality of directions,
wherein an indentation is defined between the base section and shroud section when the shroud section is in the first configuration, where said indentation forms a catch to utilize in adjusting the shroud section from its first configuration to its second configuration.

20. The lamp assembly of claim 19 wherein the indentation is formed via a protruding outer surface profile from an end of one of the base section and the shroud section, wherein the profile suspends the end of the shroud section from entirely contacting the end of the base section when the shroud section is in the first configuration.
